(19) United States
(12) Patent Application Publication
(10) Pub. No.: US 2026/0200449 A1
(43) Pub. Date: Jul. 16, 2026

(54) PRESSURE-SENSOR-BASED CONTROL OF THE REAR AXLE IN A BRAKING SYSTEM

(71) Applicant: KNORR-BREMSE SYSTEME FÜR NUTZFAHRZEUGE GMBH, München (DE)

(72) Inventors: Friedbert Röther, Cleebronn (DE); Stefan Niedermeier, Haarbach (DE); Martin Krahl, Ludwigsburg (DE); Kevin Kunert, Rutesheim (DE)

(21) Appl. No.: 19/135,679

(22) PCT Filed: Dec. 4, 2023
(86) PCT No.: PCT/EP2023/084147

§ 371 Date: Jun. 4, 2025

(30) Foreign Application Priority Data
Dec. 21, 2022 (DE) 102022134254.9

(51) Int. Cl. B60T 13/68; B60T 7/04; B60T 8/171; B60T 8/18; B60T 8/30; B60T 17/22

(52) U.S. Cl. CPC B60T 13/683; B60T 7/04; B60T 8/171; B60T 8/18; B60T 8/303; B60T 17/22; B60T 2220/04; B60T 2250/00; B60T 2270/10; B60T 2270/30

(57) ABSTRACT

A braking system for a vehicle, in particular a commercial vehicle. The braking system includes a first pressure source, a foot brake valve for receiving a deceleration request from the driver, which is connected to the first pressure source. The braking system includes a first braking module, at least one brake actuator, which is connected to the braking module, wherein the first braking module is designed to control a braking force of the at least one brake actuator in every braking procedure. The braking system includes at least a first pressure sensor, which is designed to measure the set pressure of the footbrake valve. A deceleration request from the driver can therefore be detected by pressure sensing in every braking procedure, and the rear axle is controllable without a complete electronic braking system needing to be implemented.

The present invention deals with the control of brakes on rear axles which, in a braking system, is performed by using a pressure sensor.

In commercial vehicles, in particular in trucks, the use of anti-lock braking systems (ABS) is usual.

For example, the prior art discloses the document DE 10 2019 202 770A1 , which comprises an operating method for anti-lock braking systems of a vehicle in order to determine a road condition. A first braking value is acquired after the anti-lock braking system has been activated. The anti-lock braking system can then be deactivated. A second braking pressure can then be acquired, and finally a pressure difference between the first and second braking pressure can be detected. A road condition can be determined by using this pressure difference.

In a regular anti-lock braking system, the locking of the wheels can be prevented or at least reduced, here pressure control on the brake cylinders taking place during rapid braking or emergency braking (but not during normal operational braking). A more complicated system is the so-called electronic braking system (EBS system); here the total control of all the axles and wheels is carried out electronically. A driver's braking request is determined here, for example, by a footbrake module via travel sensing (measurement of the extent to which the footbrake module is actuated, with the aid of sensors), and the travel signal (measured travel by which the footbrake module is actuated) is processed further by a brake management system. Here, different software functions are possible, for example ABS (anti-lock braking system), ESP (electronic stability program), ASR (traction control), coupling force control and load-dependent control. During normal braking, pressure control is carried out on all the axles.

In comparison with the ABS system, an EBS system is considerably more complicated and more expensive. However, it would also be desirable to be able to perform load-dependent control during each braking procedure, in particular including control of the rear axle, in normal ABS systems.

It is an object of the present invention to permit load-dependent control of the rear axle in a commercial vehicle during each braking procedure but without implementing an entire EBS system.

This object is achieved by a braking system as claimed in claim 1. Further advantageous refinements of the present invention are the subject matter of the subordinate claims.

A braking system according to the invention for a vehicle comprises: a first pressure source, a footbrake valve for receiving a deceleration request from the driver, which is connected to the first pressure source. The footbrake valve is in turn pneumatically connected to a first braking module, and at least one first brake actuator is in turn connected to the latter. Preferably, two first brake actuators are provided for the rear axle, one for each side.

The first braking module is designed to control a braking force of the at least one brake actuator during each braking procedure. This means that control is intended to take place not only during rapid braking or emergency braking but during each braking procedure. In addition, the braking system according to the invention includes at least one first pressure sensor, which is designed to measure the set pressure of the footbrake valve.

Thus, during each braking procedure, control can be performed and the braking force on the rear axle can also be controlled electronically in accordance with the driver's request (and the deceleration request of the driver is also taken into account). A more expensive footbrake module, in which travel sensing takes place (therefore an electronic signal can be measured) can therefore be dispensed with here—for this reason the pressure sensor is provided which, during each braking procedure, checks the driver's request by the set pressure of the footbrake valve being measured and used accordingly for the control. As compared with a regular ABS system, it is also possible to achieve the advantage here that, in particular, the rear axle can be controlled not only during specific braking procedures but during all braking procedures. Thus, load-dependent control of the rear axle is also possible. It is made possible, as in a normal EBS system, to determine the driver's request but as a result of a pressure measurement of the set pressure of the footbrake valve, and pressure control of the rear axle can thus be made possible. By means of this specific pressure control of the rear axle, a number of software functions can be enabled. It is possible for functions of an EBS system to be integrated in an ABS system without the higher costs of an EBS system having to be expended here.

Preferably, the at least one first brake actuator, which can be controlled by a braking force, is provided on the rear axle of the vehicle. Thus, all the above-described advantages can be implemented on the rear axle of the vehicle.

Preferably, the first pressure sensor is connected to the first braking module, and the pressure values measured by the first pressure sensor can be read into the braking module. Thus, electronic control for the rear axle can also be performed by the first braking module.

Preferably, the deceleration request can be set by means of two first brake actuators (on the rear axle) by using a solenoid valve or relay valve, wherein the respective one solenoid valve or relay valve is preferably integrated in the first braking module. The first braking module preferably includes electronic control components but also the appropriate valves with which the pressure on the corresponding brake actuators, for example brake cylinders, can be set. As a result, at least three wiring harnesses which would be needed for the solenoid activation of valves in a conventional system can be saved.

In each case a further, second pressure sensor is provided between a solenoid valve or relay valve and the corresponding brake actuator, being designed to measure the pressure set by the solenoid valve or relay valve. The second pressure sensors are likewise connected to the first braking module and can supply corresponding measured pressure values to the first braking module. Thus, pressure-based control of the rear axle can be carried out (closed control loop), based on measured values from the footbrake module via the first pressure sensor (driver's request) and second pressure sensors which measure the set pressures on the brake actuators of the rear axle. Despite the control of the braking forces of the rear axle, it is always possible to accommodate the driver's request, i.e. including the deceleration request.

Preferably, the first braking module is designed to implement the control by using software functions, wherein an anti-lock braking system, an electronic stability program and/or load-dependent control can preferably be implemented.

Preferably, the braking system also has an axle-load determination device, which is designed to determine an axle load. The axle-load determination device is connected to the first braking module, and the first braking module is designed to take the axle load into account during the control.

For example, the axle-load determination device is an axle-load sensor. However, the axle load can also be calculated by various calculation steps on the basis of other data. Thus, the possibility of load-dependent control of the rear axle is considerably improved.

Preferably, the braking system also has a second pressure source, which is likewise connected to the brake valve. In addition, there is a second braking module, which is likewise connected to the footbrake module and, in addition, at least one further brake actuator, which is connected to the second braking module, wherein the second braking module is designed to control the braking force of the at least one further brake actuator. This can relate, for example, to the front axle. In each case a pressure control valve is provided between the second braking module and at least one further brake actuator. This can be used for the fine control of the pressures on the front axle. Thus, a second brake circuit is therefore implemented.

Preferably, the at least one first pressure sensor is integrated in a first braking module. Thus, it is also possible to avoid expenditure on wiring, and furthermore very compact and space-systems are thus possible.

The present invention will now be described in more detail with reference to the appended drawings.

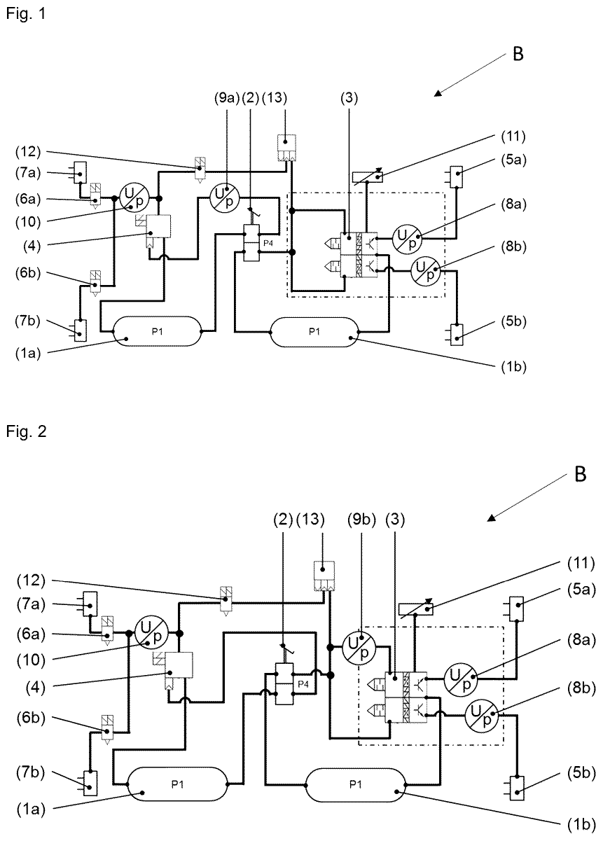

FIG. 1 shows a braking system according to the invention, wherein the pressure measurement is provided by the first pressure sensor in the brake circuit for the front axle.

FIG. 2 shows a braking system according to the invention, wherein the pressure measurement is provided by the first pressure sensor in the brake circuit for the rear axle.

FIG. 1 shows a structure of a braking system B, two brake circuits being provided here, one for the front axle and one for the rear axle. A second pressure source 1a is connected to the footbrake valve 2. The pressure originating from the second pressure source 1a can be passed on from the footbrake valve 2 to a second braking module 4. A first pressure sensor 9a is provided between the footbrake valve 2 and the second braking module 4. This first pressure sensor 9a measures the deceleration request from the driver, which the latter indicates by means of the footbrake valve 2. Downstream of the second braking module 4, a further, third pressure sensor 10 is provided; this measures the controlled pressure of the front axle, since the second braking module 4 is connected to corresponding brake cylinders 7a and 7b of the front axle. Between the third pressure sensor 10 and the corresponding brake cylinders 7a, 7b, further corresponding pressure control valves 6a and 6b are provided; these perform the fine control of the braking pressure on the front axle.

A first pressure source 1b is likewise provided with the footbrake valve 2. The pressure set by the footbrake valve 2 is supplied to a first braking module 3 in this brake circuit. The first braking module 3 receives the measured pressure value from the first pressure sensor 9a. The pressure is passed on from the first braking module 3 to the first brake actuators 5a and 5b; these are responsible for the rear axle. Further corresponding second pressure sensors 8a and 8b are connected between the first braking module 3 and the corresponding brake cylinders 5a and 5 for the rear axle, measuring the set pressure for the brake actuators 5a and 5b of the rear axle. These are also read by the second braking module 4, so that appropriate control can be carried out here. Also provided with the second braking module 4 is an axle-load determination device 11, formed here as an axle-load sensor. Also provided is a trailer control valve 13; this receives the set pressure of the footbrake valve 2. The trailer control valve is also connected to the first braking module 3. Furthermore, the trailer control valve 13 is also connected via a trailer pressure control valve 12 to the second braking module 4 which is provided for the front axle. Thus, the brakes of a trailer can also be activated appropriately when the braking system of the trailer is connected to the trailer control valve 13.

FIG. 2 shows a second embodiment of the present invention, in which all the parts are virtually identical to the first embodiment. Here, the first pressure sensor 9b is provided between the footbrake valve 2 and the first braking module 3. Here, the pressure measurement of the driver's request or the deceleration request is carried out between the footbrake valve 2 and the first braking module 3 which is assigned to the rear axle.

The driver's request to decelerate the vehicle (designated by P4 in FIGS. 1 and 2) is achieved by the actuation of the footbrake valve 2, wherein the valve 2 fed from the supply pressure 1a or 1b increases the pressure appropriately in the brake control line P4 which leads to the first braking module 3. The pressure in the brake control line P4 is measured by at least one first pressure sensor, depending on the embodiment by the first pressure sensor 9a or 9b. In the embodiment in FIG. 1, the pressure sensor 9a is fitted between the footbrake element 2 and the second braking module 4, which is assigned to the front axle. In FIG. 2, the first pressure sensor 9b is provided between the footbrake valve 2 and the first braking module 3, which is assigned to the rear axle. The first pressure sensor 9a or 9b can, however, also be integrated in the first braking module 3 or in the footbrake valve 2.

The signal from the pressure sensor 9a or 9b is read appropriately into the first braking module 3 and then a pressure set point for the brake line of the rear axle is output. This pressure is controlled by activating the solenoid or brake valve of the rear axle via at least one relay valve (not illustrated here), and additionally then measured via a respective second pressure sensor 8a, 8b, which is provided between the first braking module 3 and the corresponding brake actuators 5a and 5b of the rear axle. Therefore, pressure-based control of the rear axle is possible while taking the driver's request into account (via the first pressure sensor 9a or 9b), and on the basis of the measured values from the pressure sensors 8a, 8b which measure the set pressure of the first braking module 3. For this reason, all software-based control possibilities can be implemented in the first braking module 3. With the aid of an axle-load determination device 11, provided as an axle-load sensor here, load-dependent control of the rear axle is even possible in a less expensive ABS system without all the components for an EBS having to be implemented in a corresponding way here.

For this reason, both installation outlay and costs can be reduced significantly.

The present invention is not restricted to the aforementioned embodiments. The first pressure sensor 9a and 9b can also be provided directly in the footbrake valve 2 or integrated in other components.

### List of Reference Symbols

B Braking system
F Vehicle
1a Second pressure source (pressure supply for front axle)
1b First pressure source (pressure supply for rear axle)
2 Footbrake valve (FBV)
3 First braking module (rear axle+CPU)
4 Second braking module (front axle/relay valve/FAM)
5a Brake actuator/brake cylinder rear axle right
5b Brake actuator/brake cylinder rear axle left
6a Pressure control valve (PCV) front axle right
6b Pressure control valve (PCV) front axle left
7a Brake cylinder front axle right
7b Brake cylinder front axle left
8a Second pressure sensor (controlled pressure (P2) rear axle right)
8b Second pressure sensor (controlled pressure (P2) rear axle left)
9a First pressure sensor (driver's request (P4) front axle upper circuit)
9b First pressure sensor (driver's request (P4) rear axle upper circuit (external/integrated))
10 Third pressure sensor (controlled pressure (P2) front axle)
11 Axle-load determination device (axle-load sensor/axle-load calculation)
12 Trailer pressure control valve (TPCV)
13 Trailer control valve (TCV)

1. A braking system for a vehicle, comprising:
a first pressure source;
a footbrake valve for receiving a deceleration request from a driver, wherein the footbrake valve is connected to the first pressure source;
a first braking module;
at least one brake actuator which is connected to the braking module,
wherein the first braking module is configured to control a braking force of the at least one brake actuator during each braking procedure; and
at least one first pressure sensor, which is configured for measuring the set pressure of the footbrake valve.

2. The braking system of claim 1, wherein the at least one first brake actuator of which the braking force can be controlled is provided on a rear axle of the vehicle.

3. The braking system of claim 1, wherein the first pressure sensor is connected to the first braking module and pressure values measured by the first pressure sensor can be read into the braking module.

4. The braking system of claim 1, wherein the deceleration request is controlled by two brake actuators via a respective solenoid valve or via a relay valve, wherein the respective one solenoid valve or the relay valve is integrated in the first braking module.

5. The braking system of claim 4, further comprising:
second pressure sensors provided between the solenoid valve or the relay valve,
the corresponding brake actuator being configured for measuring a pressure set by the solenoid valve or the relay valve, wherein the second pressure sensors are connected to the first braking module.

6. The braking system of claim 1, wherein the first braking module is configured to implement control,
wherein an anti-lock braking system, an electronic stability process, program and/or a load-dependent control is implemented.

7. The braking system of claim 1, further comprising:
an axle-load determination device configured to determine an axle load,
wherein the axle-load determination device is connected to the braking module, and
the braking module is configured to take the axle load into account during the control.

8. The braking system of claim 7, wherein the axle-load determination device is an axle-load sensor.

9. The braking system of claim 2, further comprising:
a second pressure source, which is connected to the footbrake valve;
a second braking module, which is connected to the footbrake valve;
at least one further brake actuator, which is connected to the second braking module;
wherein the second braking module is designed to control a braking force of the at least one further brake actuator, wherein the at least one further brake actuator is provided on the front axle of the vehicle, wherein in each case a pressure control valve is provided between the second braking module and the at least one further brake actuator.

10. The braking system of claim 1, wherein the at least one first pressure sensor is integrated in the first braking module.
